(19) United States
(12) Patent Application Publication
(10) Pub. No.: US 2011/0193787 A1
(43) Pub. Date: Aug. 11, 2011

(54) INPUT MECHANISM FOR PROVIDING DYNAMICALLY PROTRUDING SURFACES FOR USER INTERACTION

(76) Inventors: Kevin Morishige, Los Altos, CA (US); Eric Liu, Santa Clara, CA (US); Yoon Kean Wong, Redwood City, CA (US)

(21) Appl. No.: 12/703,637

(22) Filed: Feb. 10, 2010

(51) Int. Cl. G06F 3/041

(52) U.S. Cl. 345/173

(57) ABSTRACT

A computing device including a housing, an input region, and a protrusion mechanism. The input region is provided with at least an exterior surface of the housing. The protrusion mechanism is operatively positioned within the housing to dynamically form one or more protrusions that extend from a corresponding one or more designated areas on the exterior surface of the input region. One or more detectors are structured to detect an occurrence of a condition or criteria to trigger the protrusion mechanism in dynamically generating the one or more protrusions.

### TECHNICAL FIELD

The disclosed embodiments relate to input mechanisms for computing devices. In particular, the disclosed embodiments pertain an input mechanism for providing dynamically protruding surfaces for user interaction.

### BACKGROUND

Computing devices, particularly mobile computing devices and other small form-factor computing devices, often require heavy use of scroll input from a user. Generally, scroll input allows for users to linearly navigate the display of content on a computing device. In mobile computing devices, for example, much of the user's actions are centered about selecting and viewing data or content. Lists, such as those that comprise contact records or messages, are examples of computing device content that is typically scrollable in north/south (and sometimes east/west) directions in order to enable the user to scan and view numerous records with ease.

### BRIEF DESCRIPTION OF THE DRAWINGS

FIG. 1A and FIG. 1B are simplified side-cross sectional views of a computing device that is configured to include a dynamically formed protruding input mechanism, according to embodiments described herein.

FIG. 2 illustrates methods for implementing a dynamic protrusion layer as an input mechanism, according to embodiments described herein.

FIG. 3A and FIG. 3B illustrate a keyboard arrangement on which one or more embodiments may be implemented.

FIG. 4A and FIG. 4B illustrate an alternative key set arrangement for use with dynamically formed protrusions, under an embodiment.

FIG. 5A and FIG. 5B illustrates another implementation in which an application or mufti-function structure is raised from the input area, under an embodiment.

FIG. 6A and FIG. 6B illustrate a stack arrangement that incorporates a micro-fluidic mechanism for enabling dynamic generation of protrusions, according to an embodiment.

FIG. 6C illustrates a variation to using a sensor set as a detection mechanism, under another embodiment.

FIG. 6D illustrates a variation in which the detection mechanism is provided by a resistive or pressure sensor, under another embodiment.

FIG. 6E illustrates an embodiment in which multiple protruding mechanisms overlay and actuate a common snap-dome or other electrical switch element, under another embodiment.

FIG. 7A and FIG. 7B illustrate a variation in which a protruding mechanism is formed by a lift, under another embodiment.

FIG. 8A and FIG. 8B illustrate another variation in which a protruding mechanism is equipped to provide one or more protruding or raised structures for input.

FIG. 9A and FIG. 9B illustrate another type of protruding mechanism for providing one or more raised structures, according to another embodiment.

FIG. 10A and FIG. 10B illustrates an embodiment that incorporates use of a flexible display or illumination layer in connection with protrusion mechanisms such as described with prior embodiments, under another embodiment.

FIG. 11 illustrates another embodiment in which contactless, tactile feedback (CTF) is provided for interactive finger movement that graze or come near an input surface of a computing device, according to one or more embodiments.

FIG. 12 illustrates a hardware diagram for a computing device that is configured to support any of the embodiments described herein.

### DETAILED DESCRIPTION

Embodiments described herein provide for an input mechanism of a computing device that includes dynamically generated protrusions to facilitate the user's interaction with the computing device. In particular, embodiments described herein include a computing device with dynamically available protrusions that can be associated with buttons or other input features. A user interaction with such protrusions may be processed in connection with user input, such as for scrolling, application launch, key entry or other input. Such protrusions may be configured to enable, for example, buttons or keys “on demand”.

Accordingly, embodiments described herein include a computing device that comprises a housing, an input region, and a protrusion mechanism. The input region is provided with at least an exterior surface of the housing. The protrusion mechanism is operatively positioned within the housing to dynamically form one or more protrusions that extend from a corresponding one or more designated areas on the exterior surface of the input region. One or more detectors are structured to detect an occurrence of a condition or criteria to trigger the protrusion mechanism in dynamically generating the one or more protrusions.

As used herein, the terms “programmatic”, “programmatically” or variations thereof mean through execution of code, programming or other logic. A programmatic action may be performed with software, firmware or hardware, and generally without user-intervention, albeit not necessarily automatically, as the action may be manually triggered.

One or more embodiments described herein may be implemented using programmatic elements, often referred to as modules or components, although other names may be used. Such programmatic elements may include a program, a subroutine, a portion of a program, or a software component or a hardware component capable of performing one or more stated tasks or functions. As used herein, a module or component, can exist on a hardware component independently of other modules/components or a module/component can be a shared element or process of other modules/components, programs or machines. A module or component may reside on one machine, such as on a client or on a server, or a module/component may be distributed amongst multiple machines, such as on multiple clients or server machines. Any system described may be implemented in whole or in part on a server, or as part of a network service. Alternatively, a system such as described herein may be implemented on a local computer or terminal, in whole or in part. In either case, implementation of system provided for in this application may require use of memory, processors and network resources (including data ports, and signal lines (optical, electrical etc.), unless stated otherwise.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Overview

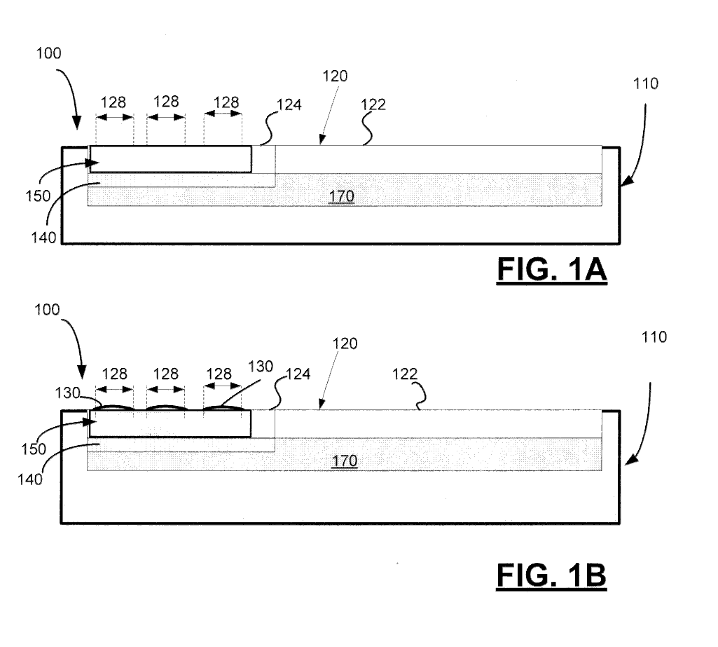

FIG. 1A and FIG. 1B are simplified side-cross sectional views of a computing device that is configured to include a protrusion mechanism for dynamically extending user contact surfaces from the computing device, according to embodiments described herein. In FIG. 1A, a computing device 100 is depicted in which a protrusion mechanism 150 is an off-state, so as to not protrude or extend a surface from the computing device 100. In FIG. 1B, the computing device 100 is depicted in which the protrusion mechanism is an on-state, so as to protrude or extend contact surfaces 130 (FIG. 1B) for user interaction.

With reference to FIG. 1A and FIG. 1B, computing device 100 includes a housing 110 having an exterior surface 120 on which a plurality of user-interface features are provided. The housing 110 contains numerous components of the computing device, including processors, memory, drivers, a power source and other components. According to embodiments, protrusion mechanism 150 is integrated or provided to enable dynamic (e.g. “on-demand”) protrusion of contact surfaces 130 (FIG. 1B). As described with other embodiments, the dynamic protrusion mechanism 150 may be combined with one or more detectors to detect one or more of (i) a contact or other event that is designated to trigger the contact surfaces 130 to be dynamically formed; and/or (ii) whether the user has pressed one of the contact surfaces 130 to enter input; and/or (iii) which of the contact surfaces 130 (if more than one are generated) was pressed. In an embodiment shown by FIG. 1A and FIG. 1B, the detector includes one or more sensors (or sensor array) 140, positioned to detect presence and/or position of a user's finger (or other input object). More than one type of detector may be used. Furthermore, some embodiments may use separate detectors to detect when the protruding contact surfaces 130 are to be dynamically formed, as compared to detectors that are used to interpret user interaction with the protruding contact surfaces.

According to embodiments, the protrusion mechanism 150 is coupled and provided over a backplane or substrate. In some embodiments such as depicted by FIG. 1, the backplane or substrate includes or provides illumination that underlies the input area 124 and contact surfaces 130 (when formed). Still further, in one embodiment, illumination layer 170 is in form of a content generating illumination device, such as a liquid crystal display (LCD) or organic light emitting diode (OLED) display. In this form, illumination layer 170 may extend under the display surface 122. Thus, under one implementation, the illumination layer 170 provides display surface 122, and at least portions of input surface 124 (including designated areas 128/protrusions 130) are provided. In some variations, embodiments may incorporate non-illuminating display or display technology, such as e-ink or electrowetting displays. Such displays may be provided adjacent to or under the designated areas 128/protrusions 130.

The exterior surface includes display area 122 and an input region 124. The input region 124 includes one or more designated areas 128 (FIG. 1A) from which contact surfaces 130 (FIG. 1B) are formed in response to one or more conditions that signify user's need or desire for physical, raised structures. According to some embodiments, the computing device 100 is able to process input made by way of the user making contact with individual contact surfaces 130 (when formed as shown by FIG. 1B), or even with designated areas 128 when the protruding contact surfaces are not formed.

According to some embodiments, the designated areas 128 and/or protruding contact surfaces 130 are positioned to operate cooperatively with the sensor array 140. The sensor array 140 is able to detect and map the user's finger (or other user directed object) and determine one or more of (i) whether the user interacted with any of the protruding contact surfaces 130; and (ii) which of the protruding contact surfaces the user interacted with. Depending on implementation, the interaction(s) may be in form of touch, pressure or force, or proximately positioned (but non-contacting) movements. As described elsewhere, sensors such as capacitive, resistive/force sensors, or optical sensors, may be used to detect user interaction. While an embodiment depicted illustrates sensor array 140 to underlie the input region 124, other implementations position the sensor array (or just sensor) 140 adjacent or near the designated areas 128 or protruding contact surfaces 130. The sensor array 140 detects the position of a finger or object that is received on either the designated area 128 (FIG. 1A) or the protruding contact surface 130 (FIG. 1B). In this way, a processor (not shown) or other logic (such as provided by integrated circuits) may detect when and which protruding contact surface 130 (or input region 128) the user makes contact when processing input or user-interaction with the computing device.

Portions of input region 124 that fall outside of the designated areas 128 may have dimensions and shape in accordance with design and form factor criteria of the device. For example, as shown, a remainder of the input region 124 that excludes the designated areas 128 may be substantially flat or co-planar, and an exterior of the input region 124 may be flush with the display area 122. Numerous other variations to the input surface 124 are possible. While FIG. 1A and FIG. 1B illustrate that the display area 122 and the input region 124 are flush or substantially co-planar, in other embodiments, the display area 122 is provided with less thickness than the input region 124. Additional input mechanisms (e.g. touch areas, buttons) may also be included in the input area 124, or elsewhere on the surface 120.

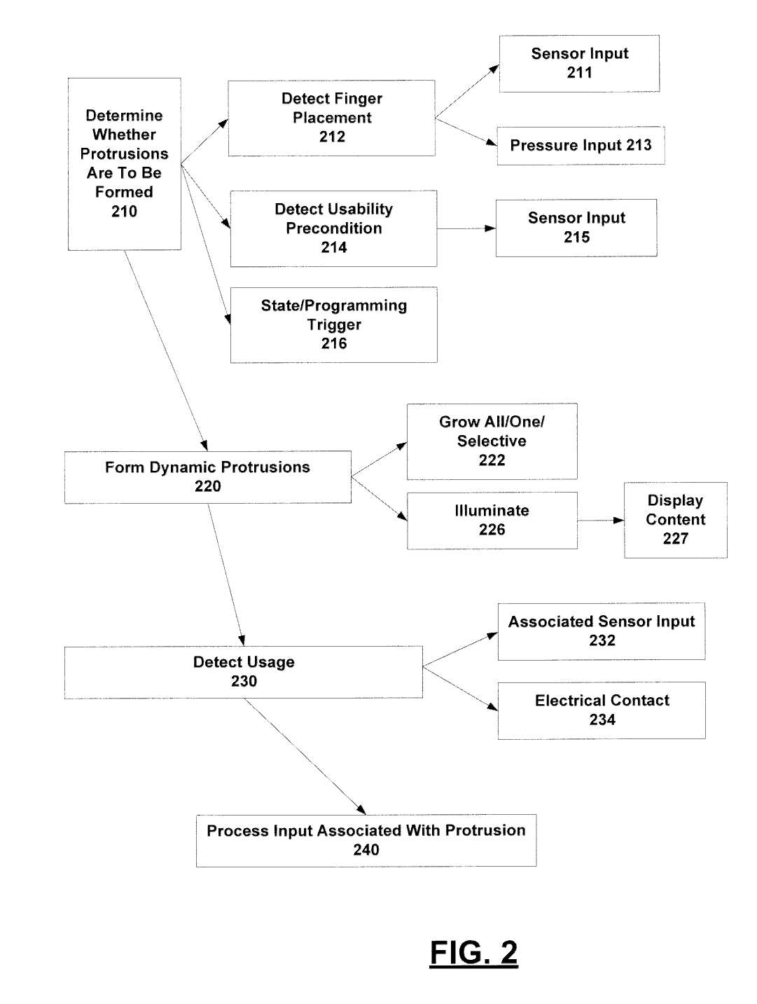

FIG. 2 illustrates methods for implementing a protrusion mechanism for dynamically forming contact surfaces for user interaction, according to embodiments described herein. In describing embodiments of FIG. 2, reference is made to elements described with FIG. 1A or FIG. 1B for purpose of illustrating suitable elements or components for implementing a step or sub-step being described. A method such as described may be implemented using processing resources and/or a combination of logic (e.g. processor, integrated circuits etc.) of computing device 100 (FIG. 1A).

In step 210, computing device 100 makes a programmatic determination as to whether protruding contact surfaces 130 are to be dynamically formed over the input surface 124. In an embodiment, the determination is based on one or more conditions or criteria that are indicative of the device being (or about to be) used in a manner in which protruding contact surfaces 130 would be desired or conducive to the user's interaction with the device. These conditions may correspond to, for example, an indication that the user is about to provide input into the device, or to provide a series of inputs or interactions. According to some embodiments, the one or more conditions correspond to device logic detecting the user's finger placement at or near the input region 124 (FIG. 1A) (212). In one implementation, the user finger placement may be detected by sensor input (211), determined by one or more sensors (or sensor array) 140 (FIG. 1A). Examples of suitable sensors include capacitive or optical sensors. As an alternative to sensor input, a button press or other user pressure input can be detected (213). For example, the protruding contact surfaces 130 (FIG. 1B) are formed in response to the user initiating use of keys that include on-demand, grown keys.

In another variation, the condition for providing protruding contact surfaces are made in response to detecting the user's hand position (214) in a manner that is indicative of the user's intent to enter input. For example, the user's hand is detected as gripping the device in a manner that is pre-cursor to user input activity. Sensor input 215 may be used to determine that the user is gripping the device. Sensor input 215 for indicating the user gripping or holding the device may correspond to, for example, touch (e.g. capacitive) or pressure sensors positioned on or about the housing 110 (FIG. 1A and FIG. 1B) of the computing device 100. Other examples of sensor input 213 include accelerometer input that indicates the user has picked up the device.

Still further, the condition for dynamically forming contact surfaces 130 are made in response to a device state and/or programmatic condition (216). The device state may be set by the user performing some action to, for example, (i) switch the computing device 100 ‘on’ (or into an operative state), (ii) select or launch an application, and (iii) responding (or not responding) to an alert or alarm. The device state may also correspond to an application state, such as the state of a game that the user is engaged in. As additional examples, the user may press a button or tap the display surface to switch the device from an off-state (a low power operation state in which the display may be dimmed or off) into an on-state (a high power state in which the display is on). Still further, as an alternative or variation, the device 100 may programmatically enter a state that anticipates user input or use. For example, the device may receive an email or notification, and the protruding contact surfaces 130 are dynamically formed in anticipation that the user will want to compose a response. Still further, the user may enter device preferences or setting that designate when the protruding contact surfaces 130 are to be formed. For example, a user may select to have protruding contact surfaces 130 formed by default, when the device is not in use, or each time the device is switched on.

Step 220 provides that the protruding contact surfaces 130 are dynamically formed in response to detecting the conditions (as described in step 210). In one implementation, protruding contact surfaces 130 are selectively formed to occupy the designated regions 128 (e.g. one or some protrusions 130, but not all) (222). In variations, all of the protruding contact surfaces 130 are formed at one time. According to some embodiments, when the contact surfaces 130 are formed, the individual contact surfaces 130 are illuminated (226). The illumination may be provided using, for example, discrete light sources such as LEDs, or a distributed source such as an electroluminance pad or LCD. As a further variation, the illumination may carry area or region specific content for individual contact surfaces 130, using, for example, an LCD or other display component (as shown by FIG. 1A and FIG. 1B) (227). As previously mentioned, non-illumination displays may also be used for computer-generated content. As examples, a surface of individual contact surfaces 130 may be provided with computer-generated content to display icons, letters, or numbers, consistent with an actual physical button or key. To achieve or facilitate the result, an embodiment provides that the contact surfaces 130, and any thickness separating the contact surface 130 from the illumination (or display) source, is at least partially translucent.

In step 230, structure usage is detected (e.g. key usage). In particular, usage detection includes identifying that a particular one of the contact surfaces 130 is pressed at a given instance, or subjected to user contact in a manner that warrants an input to be registered. In some embodiments, a usage detector is implemented using sensor measurements (232) and/or electrical triggers (234). Sensor measurements (232) identify the location of finger contact on the input region or corresponding area. For example, sensors (e.g. capacitive, resistive or optical) can determine coordinates of a finger touch by the user. If the coordinates overlay or match to the coordinates of one of the contact surfaces 130, a value assigned to that particular contact surface is assumed. As an alternative, electrical triggers, generated in form of switches integrated or coupled to the protrusion mechanism 150, can be used to detect usage of the protrusions (234). In one embodiment, the electrical switches are arranged so that pressure on the protruding surfaces 130 causes a connected or underlying switch to actuate.

In step 240, input corresponding to the user's interaction with one of the protruding contact surfaces 130 is processed. According to some embodiments, the input is processed as a button-press. Examples of operations that can be performed include, entering alphanumeric input, launching an application, entering the device into a particular state (e.g. ‘off’ or low-power, switch display off, turn ringer off), scroll in a particular direction, navigate, or otherwise deform protrusions. The type of interaction that can be processed includes a button-press, tap or swipe. As an alternative or variation, some types of operation may be enabled with press and hold (in which case), such as scrolling operations. A press and hold input includes detecting the coordinate of the user finger contact (e.g. which protrusion 130), as well as the duration in which the contact is maintained. For example, the logic associated with the computing device 100 may keep a timer to measure such durations. Other types of input that may be detected include flicks, which may correspond to position input that indicates a direction and/or velocity over time as the user's finger strikes the protrusion. Such flicks may be interpreted as scroll or navigational input.

Numerous other types of inputs and interactions may be enabled with embodiments described herein. Some examples are provided below.

Keyboard, Keypad and Button Usages

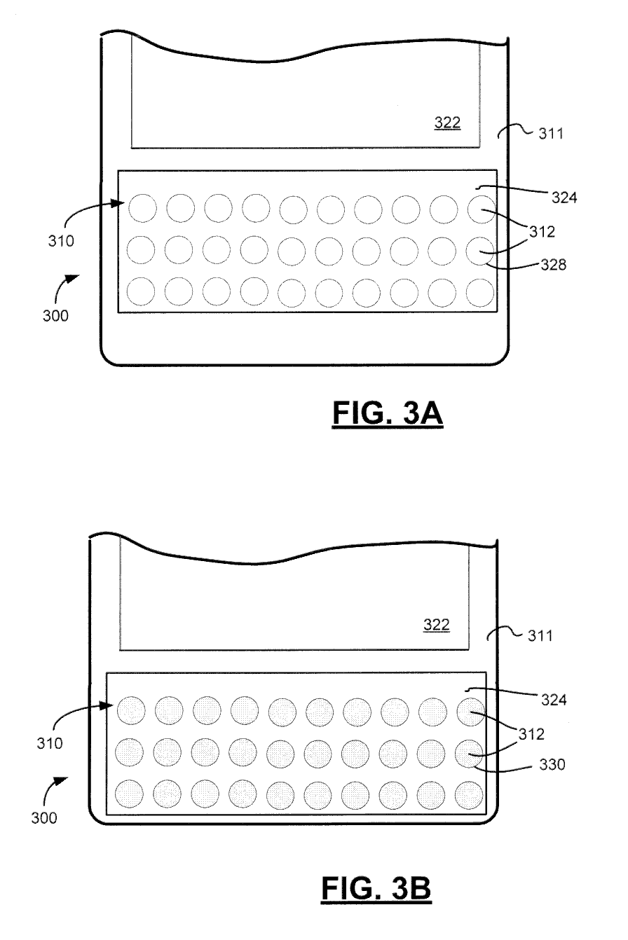

FIG. 3A and FIG. 3B illustrate a keyboard arrangement on which one or more embodiments may be implemented. In FIG. 3A, a computing device 300 includes a keyboard layout 310 having an input area 324 adjacent to or on top of a display surface 322 on a front fagade 311. The input area 324 includes a plurality of designated areas 328. FIG. 3B depicts a state in which individual key structures 312 of the keyboard 310 are provided in form of a raised structure or protrusions that dynamically formed on the designated areas 328.

In a state depicted by FIG. 3A in which the protrusions 330 (FIG. 3B) are not formed, the designated areas 328 include characteristics that make the areas visually blend, so as to hide the designated areas 328 from the remainder or surrounding portions of the input area 324. The designated areas 328 may blend by being similarly colored and/or textured with the adjacent areas of the input area. In another variation, the designated regions 328 are distinguishable from the surrounding region and can be used as flat keys. As described below, the regions are optionally illuminated with key content.

Alternatively, the input area 324 may overlay an illumination (or non-illuminative display) source (or set of discrete sources). For example, an illumination/display source may illuminate and/or provide area-specific content to the designated regions 328, so as to make the designated regions 328 operable as flat keys without protrusions. Likewise, when the computing device is in a state in which the protrusions 330 are present (as depicted by FIG. 3B), the illumination source(s) can provide key-specific content to individual keys that comprise the keyboard.

In other variations to an embodiment shown by FIG. 3A and FIG. 3B, only some key structures 312 are provided by protrusions 330, while others are permanently formed as either raised or flat structures. Still further, in other variations, the key structures 312 may be split, so as to carry two key assignments at once.

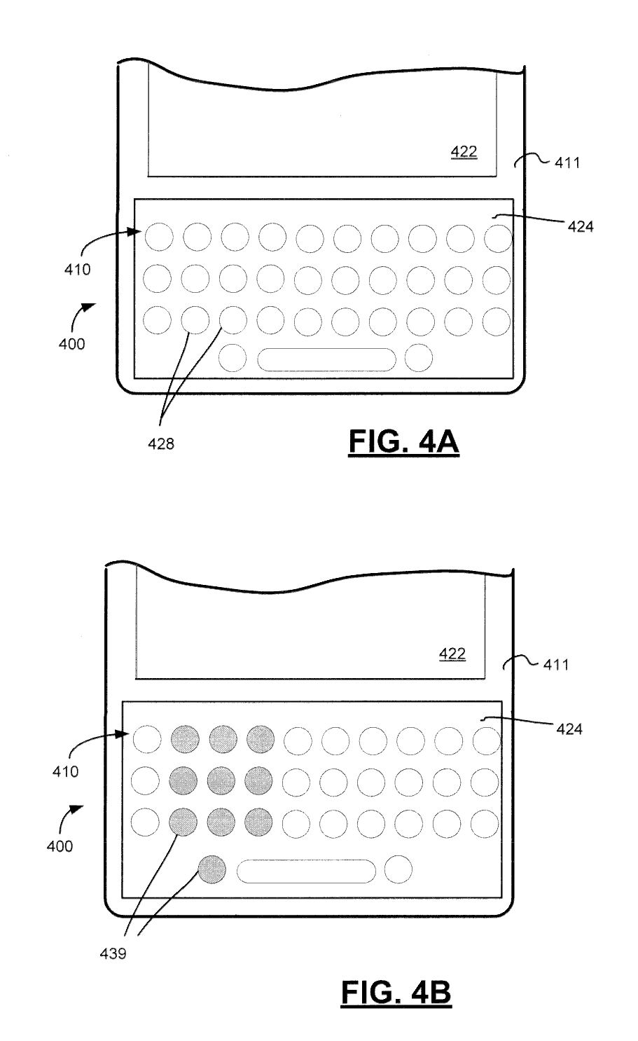

FIG. 4A and FIG. 4B illustrate an alternative key set arrangement for use with dynamically formed protrusions, under an embodiment. An embodiment such as shown may be constructed similar to that described with FIG. 3A. As such, computing device 400 includes keyboard layout 410 having an input area 424 adjacent to a display surface 422 on a front façade 411. The input area 424 includes a plurality of designated areas 428. When protrusions 430 are formed, they provide keys that collectively form a dial pad, apart from surrounding features or surface of the input area. In the example shown, the dial pad is raised to distinguish the number keys from a remainder that includes a keyboard (which are provided as flat keys). Accordingly, one implementation provides that in a state depicted by FIG. 4A, the designated regions 428 visually blend or are indistinguishable from the remainder of the input surface. In another implementation, the designated regions 428 display area specific content, such as numbers and/or alternative characters. Similarly, when the protrusions 430 are dynamically formed, an illumination component under and/or adjacent to the protrusions 430 provides each protrusion with area specific content, such as a number display.

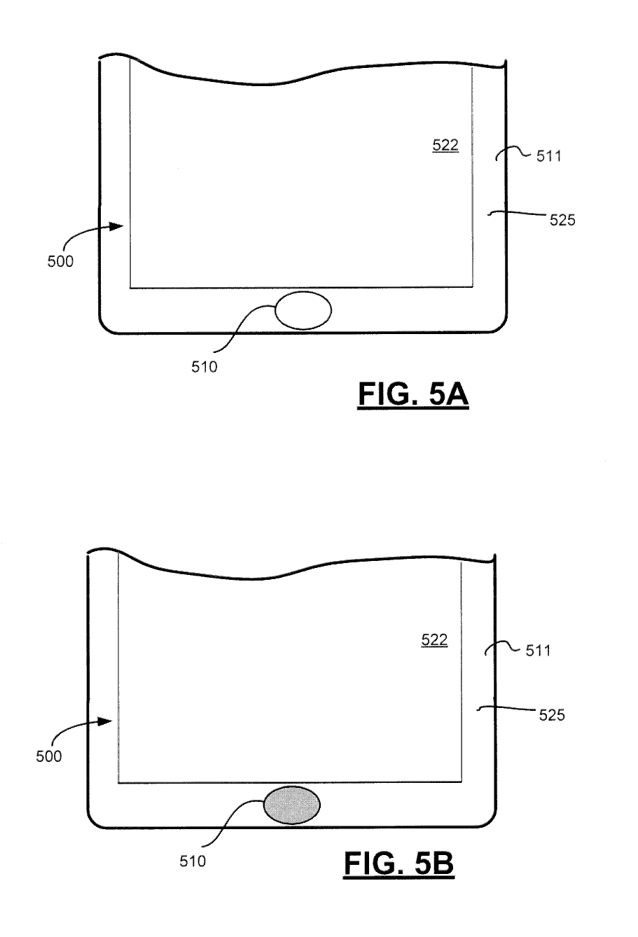

FIG. 5A and FIG. 5B illustrates another implementation in which an application or mufti-function structure is raised from the input area, under an embodiment. A computing device 500 may include a mufti-functional structure 510 on a façade 511 that includes other features, such as a display surface 522. As with previous examples, the multi-functional structure 510 may be operated in either a non-protruded state (FIG. 5A) or protruded state (FIG. 5B). Examples of the type of interaction that can be provided through the structure 510 include button swipes (e.g. to scroll, navigate or move a displayed object), button presses (e.g. to select) and press and hold (e.g. to select, or perform shortcut or multi-step actions). As with previous examples, the mufti-functional structure 510 can be illuminated in either state, depending on design and implementation. Content displayed through the multi-functional button may vary depending on whether the button is protruded (FIG. 5B) or flat (FIG. 5A).

With reference to an embodiment of FIG. 5A and FIG. 5B, the mufti-functional button may represent a single button or a set of buttons. When providing a set of buttons, separate actuation surfaces may be provided to enable directional input (e.g. north, south, east and west), as well as a center selection mechanism. Such a feature may thus provide (through one or more protruding mechanisms) a 5-way (or 8-way or 9-way) navigational selection/input mechanism.

With respect to some embodiments, the particular shape and dimension of the individual key structures or buttons formed by the dynamic protrusions (or contact surfaces) can vary, depending on design and implementation. For example, individual protrusions or contact surfaces include a footprint that is rectangular, oval, circular, or asymmetric, depending on the application. Still further, individual structures may include a flat exterior surface or one that is contoured. According to some embodiments, the protrusions extend a height that ranges between 0.3 mm and 3.0 mm when present. The designated regions, when operated as flat keys or made to visually blend to hide the key, can be substantially flat or smooth with respect to the remainder of the input surface. In some implementations, the designated regions or flat keys can have slight contours, and may extend above the input surface a height dimension that ranges between 0.0 and 0.3 mm.

Other Applications

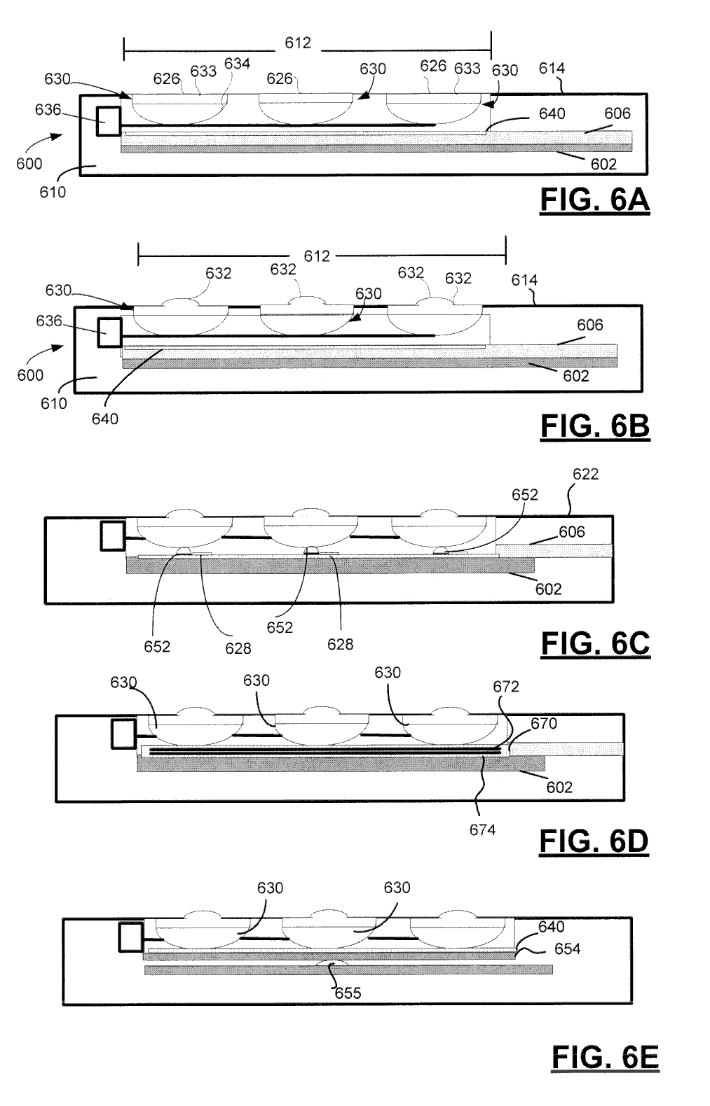

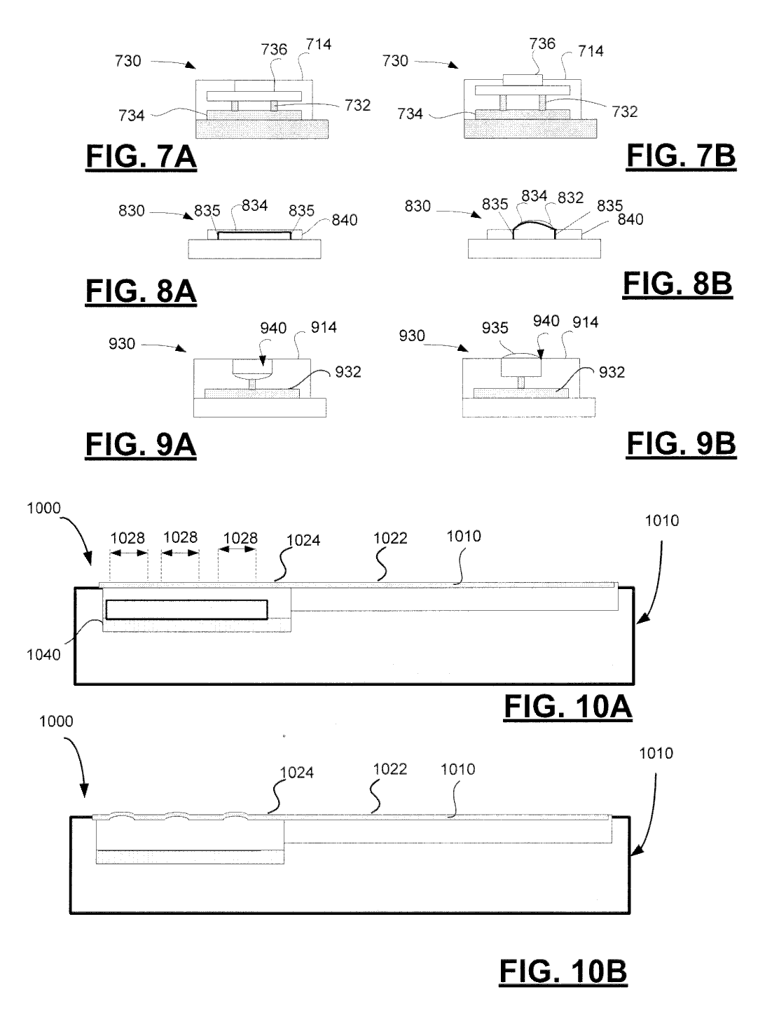

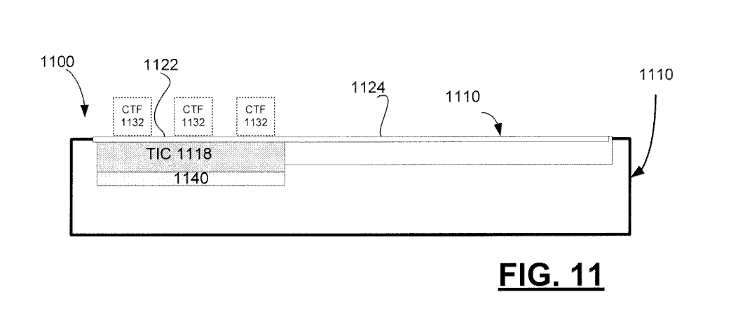

Numerous applications described herein provide for a computing device that incorporates dynamically formed or altered topology and protrusions. The various embodiments described can be formed using structures described with other embodiments, such as with FIG. 1A and FIG. 1B, as well FIG. 6A-FIG. 6E, FIG. 7A-FIG. 7B, FIG. 8A-8B, FIG. 9A-9B, FIG. 10A-10B and FIG. 11.

According to some embodiments, protrusions can be used to provide visual effects or delineators in connection with display content. For example, the protrusions use may create physical line segments that delineate or segment portions of a display surface. As another example, the protrusions may be used to highlight or otherwise distinguish words or text on a display. Still further, in a gaming scenario, the protrusions are generated in response to gaming events, and provide mechanisms for user responses and inputs.

As still another application, protrusions (such as described by any of the embodiments) may be formed into a housing portion of a device to provide an acoustic path/channel for speakers. For example, telephony devices sometimes incorporate bumps into the thickness of the device to provide an audio path in the housing for speaker output. As an alternative to providing such a fixed bump or housing structure, one or more embodiments may incorporate a housing bump in the form of one of the protrusions described herein. Such housing on-demand protrusion may be triggered by events that indicate use of the audio path, such as an event that signals a call is about to be placed or is being received.

In a variation, protrusions such as described may be provided on alternative surfaces of a computing device, such as on a back surface or side surface. The protruding mechanisms operate as input features, or provide access and/or facilitate use of input features. For example, the protrusions (with contact surfaces) such as described in FIG. 1A and FIG. 1B may be formed onto a back surface of a device (without display). Still further, on any surface, the protrusions may correspond to ridges that provide tactile delineation designating the location of another input feature. In this context, the protrusions may provide raised surfaces on which other input features can be provided. As specific examples: (i) a ridge or bump can be dynamically formed (e.g. in response to some event) in order to provide a tactile marker to another feature (e.g. a ridge can be dynamically formed to mark presence of touchpad or fingerprint reader); (ii) protrusions or contact surfaces may provide raised touchpads on a back or alternative surface of the device, in which case protrusions form (on the back or alternative surface) when an event occurs that signifies the need for the provided input feature (e.g. so as to form raised scroll bar or strip); and (iii) protrusions or contact surfaces may form to raise a fingerprint reader.

As another alternative, protrusions such as described may be positioned on a device to accommodate handedness. Specifically, certain input features of the computing device can be re-oriented to a relative left or right side to accommodate handedness or device orientation. For example, dynamically formed protrusions may be formed on opposite sides of the housing which provide common functionality (e.g. volume adjustment, power on-off). The device may employ sensors or user preference settings to determine handedness. For example, side buttons for volume adjustment or power may be formed in response to determining the handedness setting or preference. An array of buttons on a front panel may similarly be formed to accommodate handedness. In these examples, the protrusions may be formed in response to evens, such as described with other embodiments.

As still another application, the dynamic topology as described with various embodiments may be used as a mechanism to (i) signal an alert or notification, and/or (ii) prompt a user to respond to a particular event or alert. For example, a protrusion may be raised in response to an event, and the protrusion may signify or be associated with functionality that provides an appropriate response to the event. As a specific example, a protrusion may be formed in response to an alarm clock, and the protrusion may invite a press that signifies to dismiss or “snooze” the alarm.

Protrusion Mechanisms

As described with numerous embodiments, computing devices are equipped with dynamic protrusion mechanisms to form protruding contact surfaces (or protrusions), which can have the form of keys or buttons (as described above). Numerous types of mechanisms may be used to implement the dynamically protruding mechanisms described above.

FIG. 6A and FIG. 6B illustrate a stack arrangement that incorporates a micro-fluidic mechanism for enabling dynamic generation of protrusions, according to an embodiment. In FIG. 6A and FIG. 6B, a computing device 600 includes a housing 610 having an input region 612 that includes an exterior surface 614. A set of protruding mechanisms 630 are provided in a layer that occupies a thickness of the housing under the exterior surface 614. The set of protruding mechanisms 630 each underlie a corresponding designated region 626 from which a corresponding protrusion is to emerge. A sensor array 640 (e.g. a set of capacitive sensors for detecting touch) is provided in cooperative proximity to the exterior surface 614. One or more substrate layers 602 support the set of protruding mechanisms 630.

In some embodiments, the substrate layers 602 include an illumination layer 606. In an embodiment, the illumination layer 606 is a display assembly from which a display surface 614 of the device is provided. In this form, the illumination layer 606 is able to generate area-specific content (e.g. icons) for individual protrusions 630. In other variations, the illumination layer 606 corresponds to a thickness in which one or more light sources are disposed. For example, an electroluminance pad can be disposed over a substrate to provide uniform illumination over a given area that spans more than one region 626. Alternatively, as shown by FIG. 6C, the illumination layer 606 includes a plurality of discrete light sources 628 (FIG. 6C), such as LEDs, that are associated with specific regions of the exterior surface 614, such as individual regions 626. In order to enable content to be provided through the protrusion or its designated area, the fluid and chamber 633 of mechanisms 630 are clear or translucent to enable light to pass through from underneath. Alternatively, the regions surrounding or provided by the protrusions 630 can incorporate slits or openings to enable light to pass through the layer that includes the protruding mechanism. Still further, as another variation, the light from the illumination layer 606 may be provided from a location that is adjacent or over the exterior surface 614. For example, the housing 610 includes sidewalls from which the illumination components direct light onto the input surface of the device.

In one implementation, each protruding mechanism 630 extends a corresponding protrusion 632 (FIG. 6B) from the exterior surface 614. The number of protruding mechanisms 630 in use depends on the design and implementation (e.g. keyboard versus application button). Each protruding mechanism 630 includes an expandable chamber 633 that coincides with the designated region 626, and a reservoir 634. One or more pumps 636 are operatively coupled to the individual mechanisms 630. The pump(s) 636 can be electrically interconnected to trigger logic (not shown) of the computing device 600. The trigger logic may correspond to a processor of the computing device, or alternatively to integrated circuits that are structured to interpret and respond to given sensor values. The trigger logic triggers the pump when a condition is met to raise the keys. In some embodiments, the sensor set 640 connects to the processor (or other trigger logic) of the computing device to signal sensor values that indicate user contact, or presence just before contact. For example, the sensor set 640 may react to skin or electrostatic charge carried on human skin, so as to sense the presence of the user's finger prior to contact. In response, the processor signals the pump 636 to pump fluid from the reservoir 634 to the chamber 633, causing the chamber 633 to expand from the designated region 626 and form the corresponding protrusion 632 (FIG. 6B).

According to some embodiments, the dynamically formed protrusion are formed relatively quickly, with the protrusion 630 being formed in a time frame that last only a few seconds, or even less than a second, from the time the trigger logic signals the pump 636. As an addition or alternative to sensor set 640 detecting the condition that triggers the formation of protrusion 630, other implementations may use different mechanisms for triggering the formation of the protrusions 630. For example, sensors may be positioned in other locations of the housing 610 (e.g. on its underside) to detect when the housing is being gripped. Motion sensors, such as accelerometers, may be used to infer when the device is picked up or held in a condition for use. Programmatic triggers, such as a program notification or email receipt, may also be used to trigger the formation of the protrusion 630.

According to embodiments, a usage detector (or input detection mechanism) is also used to determine which protrusion the user interacts with at a given instance. For example, after an initial trigger causes multiple raised key structures (such as those needed to form a dialpad), the user's interaction with the set of raised keys requires determining which protrusions 630 the user touches or presses (e.g. when the user enters a phone number using a dialpad of raised keys). In a sensor environment, a common set of touch or finger detection sensors may be used to trigger the formation of the protrusions, as well as detect the position (or input value) of the user's interaction with a particular one of the protrusions. In one embodiment, the detection mechanism corresponds to the sensor set 640, which are positioned to detect a coordinate of each user contact with the exterior surface 614. A processor (not shown) of the computing device implements input logic that maps the coordinates of the protrusions 630 to input values. The processor determines the coordinates of each user contact by translating the coordinates of the user's contact, as determined from the input of the sensor set 640, to a value assigned to individual protrusions 630. The sensor set 640 can be implemented by, for example, a capacitive or optical set of sensors that detect either an approaching finger, or a finger in contact with the exterior surface.

FIG. 6C illustrates alternatives to using a sensor set as a detection mechanism, according to some embodiments. As shown in FIG. 6C, the detection mechanism corresponds to electrical switches that are actuated with deformation and/or inward travel of elements that comprise the protrusion mechanism 630. In one implementation, the electrical switches are provided as snap-domes 652 that are positioned just under or in contact with individual protrusion mechanisms. The snap domes 652 are further connected on substrate 602. The elements of the protruding mechanism 630 (filled chamber and emptied reservoir), when activated, may be sufficiently deformable to press inward and collapse electrical contacts 652. When collapsed, the electrical contacts 652 signal that an input occurred (including at which protrusion), much akin to a conventional button or key.

FIG. 6C also illustrates an implementation in which illumination for the display surface 622 is not used to illuminate the input mechanisms 630. In one variation, discrete light sources 628 are selectively positioned under the input mechanisms 630. The discrete light sources 628 may correspond to, for example, LEDs. To enable backlighting or other forms of illumination, the individual input mechanisms 630 may be translucent or clear, or include portions that are translucent to enable the passage of light. As an alternative or addition, slits or openings may be included to enable light to illuminate (from underneath) the surface adjacent the protrusions 632. Still further, no illumination may be provided with the protrusion mechanisms 630.

As an alternative or variation, FIG. 6D illustrates a variation in which the detection mechanism is provided by a resistive or pressure sensor. More specifically, an electrical detect layer 670 may be positioned just under, or alternatively integrated with, the individual input mechanisms 630. The electrical contact layer 670 includes mesh or separated wires 672 contained in a deformable thickness 674. When the thickness 674 is deformed with a finger press, the mess 672 switches and generates an electrical signal. The electrical detect layer 670 is coupled to a processor or other processing resource to detect, for example, the finger press that caused the electrical signal.

Still further, FIG. 6E illustrates an embodiment in which multiple protruding mechanisms 630 overlay and actuate a common snap-dome 655 or other pressure sensitive or electrical switch element. In such an embodiment, sensors 640 (e.g. capacitive sensors) are used to identify the position of the finger contact (e.g. which protrusion 632 was actually contacted by the user). The sufficiency of the contact, on the other hand, can be determined by whether sufficient travel was caused to actuate the underlying snap-dome 655. In such an embodiment, a common platform 654 can be moved inward by the user by inserting or pushing in any of the protruding mechanisms 630.

Numerous variations exist in implementing a protruding mechanism in connection with providing protrusions, as described with numerous embodiments. In FIG. 7A and FIG. 7B, the protrusion mechanism corresponds to a lift 730 that selectively raises a surface structure 736. The lift 730 includes an arm or extending structure 732, a base 734 and the surface structure 736. In a non-protruding state (FIG. 7A), the surface structure 736 is submerged to be under or flush with the exterior surface 714 of the computing device. In an extended or protruded state (FIG. 7B), surface structure 736 is extended vertically beyond the exterior surface 714. As described with some other embodiments, in the raised position, the exterior structure 736 may simulate the look and/or feel of a key or button on the exterior surface 714. In order to lift the surface structure 736 in the extended position, the base 736 may raise or tilt up using mechanical drivers.

FIG. 8A and FIG. 8B illustrate another variation in which a protruding mechanism is equipped to provide one or more protruding or raised structures for input. A protruding mechanism 830 includes a layer of deformable material 840, in which a wire 834 is extended between anchors 835. In a non-protruding state (FIG. 8A), the wire 834 is stretched by anchors 835, so that the layer of deformable material is flat. In the protruding state (FIG. 8B), the wire is pushed in, where it is forced to extend or protrude to provide for the length. The deformable material 840 is shaped when the wire 834 bows, thereby forming the protrusion 832.

FIG. 9A and FIG. 9B illustrate another type of protruding mechanism for providing one or more raised structures, according to another embodiment. In FIG. 9A and FIG. 9B, the protruding mechanism 930 is comprised of electro-reactive muscle 940. In FIG. 9A (non-extended state), a base structure 932 pulls the muscle 940, containing the material within the exterior surface 914. In FIG. 9B (extended state), the base structure 932 releases or pushes the muscle 940, so that a portion 935 extends out and forms a raised structure 936 that can be pressed or contacted by the user.

As an alternative to electro-reactive muscle, a piezoelectric element may be substituted. The piezoelectric may be pressed and biased, and then relaxed, in order to cause the element to deform and form the protruding contact surface. The piezoelectric element may carry the added benefit of generating electrical signals when pressed, so as to carry inherent capability to detect when individual structures are pressed (both in position and in sufficiency of contact to register as input).

With reference to the various protruding mechanism shown in FIGS. 7A-7B, 8A-8B, and 9A-9B, the various implementations may be combined or integrated with a detector to detect when the user intends to enter input through interaction with a protrusion (e.g. a raised key or button). In one implementation, a sensor set is used to detect presence of the user's finger on the raised structure. As an addition or variation, the electrical contact elements may be integrated with the mechanism in order to detect (i) which raised structure the user contacted, and/or (ii) the sufficiency of the contact. Likewise, illumination components as described with any other embodiments may be combined with any of the protrusion mechanisms depicted with embodiments of FIG. 7A-7B, FIG. 8A-8B, and FIG. 9A-9B.

FIG. 10A and FIG. 10B illustrates an embodiment that incorporates use of a flexible display or illumination layer in connection with protrusion mechanisms such as described with prior embodiments, under another embodiment. In FIG. 10A and FIG. 10B, computing device 1000 includes a flexible display layer 1010 that extends over an input region 1024 that overlays a set of protrusion mechanisms 1030. The display layer 1010 can extend beyond the input region 1024 to provide a display surface 1022, on which processor-generated content can be provided. A sensor layer 1040 is operatively positioned to detect information about the placement of a user's finger on or near the input region 1024. The construction of the protrusion mechanisms 1030 is consistent with those disclosed in prior embodiments. Accordingly, as discussed with some embodiments, in a non-activated state (FIG. 10A), the input region 1024 includes designated areas 1028 from which protrusions 1032 (FIG. 10B) are formed. In the activated state, protrusions 1032 are formed under the flexible display 1010, and deform and bend the display 1010 from underneath to form the protrusions 1032. The activation and formation of the protrusions 1032 is in response to some pre-determined trigger (e.g. detection of the user's finger near the input region 1024, detection of the user gripping the device, programmatic trigger). The user's selection of one of the protrusions 1032 may be through use of an electrical or sensor-based detection mechanism (e.g. underlying touch sensor). As an alternative or variation, the sensor layer 1040 can be integrated with the display layer 1010. As another variation, the sensor layer is positioned around the display layer 1010 to detect finger placement.

While some embodiments described provide for mechanisms that invite user's to press inward, other forms of input mechanisms can be created with dynamic protrusions. For example, alternative configurations may provide for dynamic protrusions to form a lever or a slide switch which the user can press against laterally. This protrusion can move so as to act as a ‘flip’ switch. The detection of this movement can be provided by a touch-sensitive sensor of any type. For instance, this physical switch could be placed on top of a standard capacitive touchscreen where the sliding of a finger moves the protrusion along the same axis. The protrusion gives lateral feedback for the swipe gesture.

Contactless Tactile Feedback

FIG. 11 illustrates another embodiment in which contactless, tactile feedback (CTF) is provided for interactive finger movement that graze or come near an input surface of a computing device, according to one or more embodiments. According to an embodiment, a device 1100 is equipped with a tactile inducing component (TIC) 1118 that induces forces for providing tactile sensation to a user's finger tip, without the finger actually making contact (or solid contact) with the underlying surface. The induced forces result in CTF 1132, which overlay designated regions on the input surface 1122 where hidden protrusions (which can be formed), soft buttons or other features overlay.

In one embodiment, the device 1100 includes an input surface 1122 and a display surface 1124. As with some other embodiments, the input surface 1122 and the display surface 1124 overlap or are extend from a common medium. Still further, some embodiments include protrusion mechanisms (not shown in FIG. 11) which enable formation of protrusions (not shown in FIG. 11) from designated areas of the input region 1124. The input region 1124 may alternatively or additionally provide contact surfaces for input (e.g. soft buttons or touch screens), flat keys or even conventional keys or buttons.

The TIC 1118 may be in any one of ways. In one implementation, the TIC 1118 induces electrostatic forces that are detectable to a user's skin. Other variations may use, for example, magnetic or sonar induced forces to generate the tactile sensation on a nearby finger.

In one embodiment, the TIC 1118 provides sensory information to enable the user to realize the location of hidden keys or buttons, just prior to the user making contact with the input surface 1124. In the context of forming keys or buttons on demand, the TIC 1118 enables the user to guide his finger to the location of a button or key prior to the button or key having been formed. In other applications, such as with touch screens that display soft buttons, or even conventional mechanical buttons, the TIC 1118 may create a sensory feel for the user to enable better coordination and button use to, for example, facilitate the user in using the input feature without looking at the input surface 1124. For example, in the context of a dialpad that is integrated with a keyboard (see FIG. 3B), the TIC 1118 may be used to provide sensory precursor feedback for enabling the user to distinguish numeric dialpad keys from other keys.

Hardware Diagram

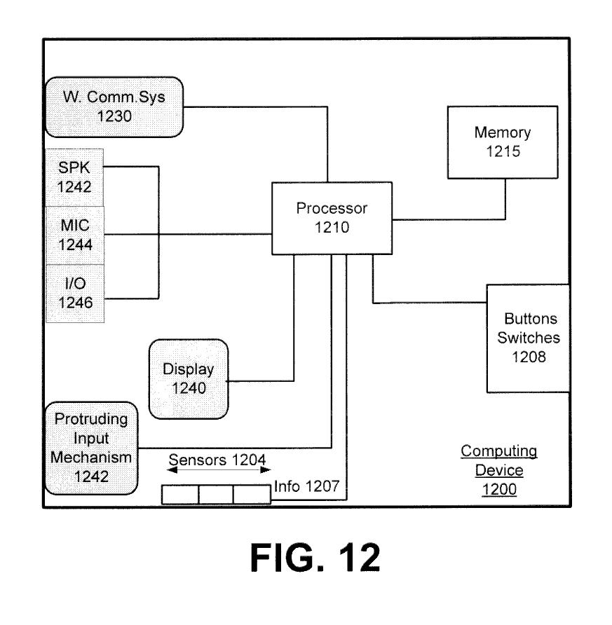

FIG. 12 illustrates a hardware diagram for a computing device that is configured to support any of the embodiments described herein. An embodiment of FIG. 12 is depicted as a mobile computing device 1200, which may correspond to any device that includes roaming wireless network and/or telephony capabilities, including cellular telephony devices and/or mobile messengers. In particular, embodiments described herein may apply to numerous kinds of mobile or small form-factor computing devices. One type of mobile computing device that may be configured to include embodiments described herein includes a computer telephony device, such as a cellular phone or mobile device with voice-telephony applications (sometimes called “smart phone”). A computing device such as described may be small enough to fit in one hand, while providing cellular telephony features in combination with other applications, such as messaging, web browsing, media playback, personal information management (e.g. such as contact records management, calendar applications, tasks lists), image or video/media capture and other functionality. Mobile computing devices in particular may have numerous types of input mechanisms and user-interface features, such as keyboards or keypads, mufti-directional or navigation buttons, application or action buttons, and contact or touch-sensitive display screens. Some devices may include combinations of keyboard, button panel area, and display screen (which may optionally be contact-sensitive) on one fagade. The button panel region may occupy a band between the keypad and the display area, and include a navigation button and multiple application buttons or action buttons.

Specific types of messaging that may be performed includes messaging for email applications, Short Message Service (SMS) messages, Multimedia Message Service (MMS) messages, and proprietary voice exchange applications (such as SKYPE). Still further, other types of computing device contemplated with embodiments described herein include laptop or notebook computers, ultra-mobile computers, personal digital assistants, and other multi-functional computing devices.

Still further, one or more embodiments may be implemented through any type of computing device is a desktop computer that is configured to include real-time voice data exchange (e.g. through use of Internet Protocol telephony). Still further, other types of computer telephony devices exist, including standalone devices that connect directly to a telephone network (whether Internet Protocol or Public Switch Telephony System (PSTN)) and provide software interfaces and applications.

According to an embodiment, the device 1200 may include one or more processors 1210 (as processing resources), memory resources 1215, one or more wireless communication ports 1230, and various other input/output features, including a display assembly 1240, a speaker 1242, a microphone 1244 and other input/output mechanisms 1246. The display assembly 1240 may be contact-sensitive (to detect presence of objects), and more specifically, touch-sensitive, to detect presence of human skin (such as the motion of a finger). According to some embodiments, the display assembly 1240 provides the interface by which the user may enter input movements to interact with applications and application content.

According to an embodiment, one or more protrusion mechanisms 1242 may be included with the computing device. The protruding mechanisms 1242 may be integrated or coupled with display assembly 1240, or provided separately. The protrusion mechanisms 1242 may further be triggered or controlled by processor 1210 (or by processing resources that comprise control logic) to dynamically provide protrusions (e.g. buttons or keys).

In some embodiments, the device 1200 includes one or more sensors 1204 (or other mechanisms) to detect sensor information 1207, corresponding to one of more of (i) presence and/or position of a user's finger on a region of a display or input surface, (ii) a detection of the device orientation or user hand orientation to indicate the device is or about to be used. As described with some other embodiments (see FIG. 2), the use of such sensor information may provide a trigger to “grow” keys or buttons. Further, as described with some embodiments, the use of such sensors may also be used detect instances and location of a user's contact with protrusions or grown keys/buttons. Other detectors, such as electrical switches, may also be used to detect instances of user interaction.

It is contemplated for embodiments described herein to extend to individual elements and concepts described herein, independently of other concepts, ideas or system, as well as for embodiments to include combinations of elements recited anywhere in this application. Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A computing device comprising:
a housing;
an input region provided with at least an exterior surface of the housing;
a protrusion mechanism operatively positioned within the housing to dynamically form one or more protrusions that extend from a corresponding one or more designated areas on the exterior surface of the input region; and
one or more detectors that are structured to detect an occurrence of a condition or criteria to trigger the protrusion mechanism in dynamically generating the one or more protrusions.

2. The computing device of claim 1, wherein the one or more detectors comprise one or more sensors that are positioned to detect a presence of contact of a user's finger on or near the exterior surface in order to trigger formation of the one or more protrusions.

3. The computing device of claim 2, wherein the one or more detectors comprise one or more touch-sensors.

4. The computing device of claim 1, wherein the one or more detectors comprise one or more sensors that detect the device being oriented or positioned in a manner that is indicative of the device being in use.

5. The computing device of claim 1, wherein the one or more detectors are configured to detect a position of a user's finger when the user physically interacts with at least one of the one or more protrusions.

6. The computing device of claim 5, wherein the one or more detectors include one or more sensors that detect which of a plurality of protrusions the user interacts with at a given instance.

7. The computing device of claim 1, wherein the one or more detectors are configured to detect (i) a presence of the user's finger in touching or pressing one or more of the protrusions, (ii) a position of the user's finger, and (iii) a sufficiency of contact in the user's finger making contact with the one or more protrusions for interpreting the user's contact as input.

8. The computing device of claim 5, wherein the one or more detectors include one or more electrical switches that are integrated or positioned so as to be actuated when a corresponding one of the one or more protrusions is pressed inward.

9. The computing device of claim 1, further comprising a discrete light source associated with the protrusion mechanism and oriented to illuminate at least a portion of at least one of the one or more protrusions.

10. The computing device of claim 1, further comprising an illumination layer that is positioned to illuminate area-specific content onto the area when the protrusion is formed.

11. The computing device of claim 10, wherein the illumination layer comprises a display assembly.

12. The computing device of claim 11, wherein the display assembly is a flexible display that is formed over the protrusion mechanism, so that the one or more protrusions are formed through the flexible display.

13. The computing device of claim 1, wherein the corresponding one or more areas on which the one or more protrusions are formed are each flush with respect to a remainder of the exterior surface when the one or more protrusion are not formed.

14. The computing device of claim 1, wherein the one or more detectors include one or more sensors that detect placement of the computing device in a hand of a user.

15. The computing device of claim 1, wherein the one or more detectors include a processor that is configured to detect one or more programmatic conditions that correspond to the condition or criterion.

16. The computing device of claim 1, further comprising a tactile inducing component that generates one or more contactless, tactile feedback regions over the input region.

17. A computing device comprising:
a housing;
an input region provides on at least an exterior surface of the housing;
a plurality of designated areas provided on the exterior surface;
one or more protrusion mechanisms that are operatively positioned relative to each designated area in order to dynamically extend a corresponding one of the one or more raised structures from the exterior surface;
a detection mechanism that is structured to detect an occurrence of a condition or criteria to trigger the protrusion mechanism in dynamically generating the protrusion.

18. The computing device of claim 17, wherein the raised structures form a keypad, a keyboard or a set of application buttons.

19. The computing device of claim 17, further comprising one or more sensors that detect placement of a finger or object on any one of the plurality of raised structures, the one or more sensors being coupled to a processor of the computing device in order to trigger a corresponding input.

20. The computing device of claim 19, wherein the one or more sensors are capacitive to detect touch by the user.

21. The computing device of claim 19, wherein the one or more sensors are resistive to detect a user's pressure input on any one of the raised structures.

22. The computing device of claim 17, further comprising one or more electrical switches that are positioned and structured to electrically actuate in response to at least one of the plurality of raised structures being pressed inward.
